(19) United States
(12) Patent Application Publication
(10) Pub. No.: US 2013/0094177 A1
(43) Pub. Date: Apr. 18, 2013

(54) WAVELENGTH CONVERSION COMPONENT WITH IMPROVED THERMAL CONDUCTIVE CHARACTERISTICS FOR REMOTE WAVELENGTH CONVERSION

(71) Applicant: Charles Edwards, Pleasanton, CA (US)

(72) Inventor: Charles Edwards, Pleasanton, CA (US)

(73) Assignee: INTEMATIX CORPORATION, Fremont, CA (US)

(21) Appl. No.: 13/273,198

(22) Filed: Oct. 13, 2011

(51) Int. Cl. F21K 2/00

(52) U.S. Cl. 362/84

(57) ABSTRACT

A wavelength conversion component for a light emitting device comprising at least one light emitting solid-state light source includes a wavelength conversion layer comprising photo-luminescent material and a light transmissive thermally conductive substrate in thermal contact with a surface of the wavelength conversion layer.

### FIELD

This disclosure relates to light emitting devices that utilize remote wavelength conversion, and particularly to apparatuses for implementing a wavelength conversion component with improved thermal conductive characteristics for a light emitting device.

### BACKGROUND

White light emitting LEDs (“white LEDs”) are known and are a relatively recent innovation. It was not until LEDs emitting in the blue/ultraviolet part of the electromagnetic spectrum were developed that it became practical to develop white light sources based on LEDs. White LEDs include one or more photo-luminescent materials (e.g., phosphor materials) which absorb a portion of the radiation emitted by the LED and re-emit light of a different color (wavelength). Typically, the LED chip or die generates blue light, and the phosphor(s) then absorbs a percentage of the blue light emitted by the LED chip to re-emit yellow light or a combination of green and red light, green and yellow light, green and orange or yellow and red light. The portion of the blue light generated by the LED that is not absorbed by the phosphor material combined with the light emitted by the phosphor provides light to an observer which appears to the eye as being nearly white in color.

Typically the phosphor material is mixed with a silicone or epoxy material and the mixture applied to the light emitting surface of the LED die. It is also known to implement “remote phosphor” configurations in which the phosphor material is provided as a layer on, or incorporate the phosphor material within, an optical component (e.g., wavelength conversion component), that is located remotely to the LED die. With such remote phosphor LED devices, one or more solid-state light emitters, typically LEDs, generate blue light which is used to excite a remote photo-luminescent wavelength conversion component that contain particles of a blue light excitable photo-luminescent material (e.g. a phosphor material).

During operation of the LED device, a significant amount of heat may be generated by the wavelength conversion component as a byproduct of the process of generating photo-luminescent light. A notable issue when implementing LED devices is the need to adequately dissipate the generated heat from the wavelength conversion component during operation of the device. The presence of excessive heat may negatively affect the performance of the phosphor material and lead to thermal degradation of various components of the LED device.

Therefore, there is a need for improved approaches to perform thermal management of heat generated by LED lighting apparatuses and/or wavelength conversion components within such apparatuses.

### SUMMARY OF THE INVENTION

Embodiments of the invention concern a wavelength conversion component with improved thermal conductive characteristics for remote wavelength conversion. In some embodiments a wavelength conversion component for a light emitting device comprises at least one light emitting solid-state light source that includes a wavelength conversion layer comprising photo-luminescent material, and a light transmissive thermally conductive substrate in thermal contact with a surface of the wavelength conversion layer.

In other embodiments a light emitting device includes at least one solid-state light source operable to generate light and a wavelength conversion component located remotely to the at least one source and operable to convert at least a portion of the light generated by the solid-state light source to light of a different wavelength. The emission product of the device comprises the combined light generated by the at least one source and the wavelength conversion component. The wavelength conversion component includes a wavelength conversion layer comprising photo-luminescent material and a light transmissive thermally conductive substrate in thermal contact with the wavelength conversion layer.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

In order that the present invention is better understood light emitting devices and wavelength conversion components in accordance with the invention will now be described, by way of example only, with reference to the accompanying drawings in which like reference numerals are used to denote like parts, and in which:

FIG. 1 illustrates a schematic partial cutaway plan and section views of a typical light emitting device that utilizes remote wavelength conversion;

FIG. 2 illustrates a cross-sectional view of a typical wavelength conversion component;

FIG. 3 illustrates a sectional view of the thermal characteristics of the light emitting device of FIG. 1;

FIG. 4 illustrates a cross-sectional schematic of a wavelength conversion component in accordance with some embodiments;

FIG. 5 illustrates a cross-section of a light-emitting device comprising the wavelength conversion component in FIG. 4 in accordance with some embodiments;

FIG. 6 illustrates a cross-section of a light-emitting device comprising the wavelength conversion component in FIG. 4 in accordance with some other embodiments

FIG. 7 illustrates a cross-sectional of a wavelength conversion component in accordance with some embodiments;

FIGS. 8A, 8B, and 8C illustrate an example of an application of a wavelength conversion component in accordance with some embodiments;

FIGS. 9A, 9B, and 9C illustrate another example of an application of a wavelength conversion component in accordance with some embodiments;

FIG. 10 illustrates another example of an application of a wavelength conversion component in accordance with some embodiments;

FIGS. 11A and 11B illustrate another example of an application of a wavelength conversion component in accordance with some embodiments;

FIGS. 12A and 12B illustrate a perspective view and a cross-sectional view of an application of a wavelength conversion component in accordance with some embodiments; and

FIG. 13 illustrates a perspective of another application of a wavelength conversion component in accordance with some embodiments.

### DETAILED DESCRIPTION OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

For the purposes of illustration only, the following description is made with reference to photo-luminescent material embodied specifically as phosphor materials. However, the invention is applicable to any type of photo-luminescent material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths. As such, the invention is not limited to phosphor based wavelength conversion components unless claimed as such.

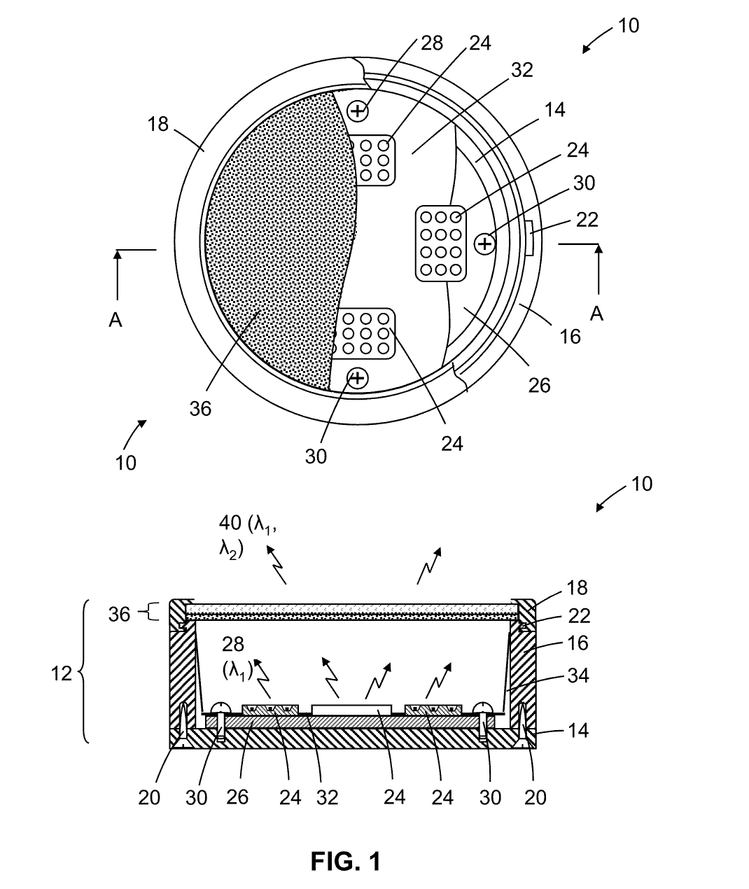

An example of a typical light emitting device that utilizes remote wavelength conversion will now be described with reference to FIG. 1 which shows a schematic partial cutaway plan and sectional views of the device. The device 10 comprises a hollow cylindrical body 12 composed of a circular disc-shaped base 14, a hollow cylindrical wall portion 16 and a detachable annular top 18. To aid in the dissipation of heat, the base 14 is preferably fabricated from aluminum, an alloy of aluminum or any material with a high thermal conductivity (preferably ≧200 Wm⁻¹k⁻¹) such as for example copper, a magnesium alloy, or a metal loaded plastics material. For low cost production the wall 16 and top 18 are preferably fabricated from a thermoplastics material such as HDPP (High Density Polypropylene), nylon or PMA (polymethyl acrylate). Alternatively, the can be fabricated from a thermally conductive material such as aluminum or aluminum alloy. As indicated in FIG. 1, the base 14 can be attached to the wall portion 16 by screws or bolts 20 or by other fasteners or by means of an adhesive. As further shown in FIG. 1 the top 18 can be detachably mounted to the wall portion 16 using a bayonet-type mount in which radially extending tabs 22 engage in a corresponding annular groove in the top 18.

The device 10 further comprises a plurality of blue light emitting LEDs 24 (blue LEDs) that are mounted in thermal contact with a circular-shaped MCPCB (metal core printed circuit board) 26. A component is in “thermal contact” with another component if it can exchange energy with the other component through the process of heat. The blue LEDs 24 can comprise 4.8 W Cetus™ C1109 chip on ceramic devices from Internatix Corporation of Fremont, Calif. in which each device comprises a ceramic packaged array of twelve 0.4 W GaN-based (gallium nitride-based) blue LED chips that are configured as a rectangular array 3 rows by 4 columns. Each blue LED 24 is operable to generate blue light 28 having a peak wavelength λ₁ in a wavelength range 400 nm to 480 nm (typically 450 nm to 470 nm). As is known an MCPCB 26 comprises a layered structure composed of a metal core base, typically aluminum, a thermally conductive/electrically insulating dielectric layer and a copper circuit layer for electrically connecting electrical components in a desired circuit configuration. The metal core base of the MCPCB 26 is mounted in thermal contact with the base 14 with the aid of a thermally conductive compound such as for example an adhesive containing a standard heat sink compound containing beryllium oxide or aluminum nitride. As shown in FIG. 1 the MCPCB can be attached to the base using screws or bolts 30.

To maximize the emission of light, the device 10 can further comprise light reflective surfaces 32, 34 that respectively cover the face of the MCPCB 26 and the inner curved surface of the housing wall 16. The light reflective surfaces 32, 34 can comprise a highly light reflective sheet material such as WhiteOptics™ “White 97” (A high-density polyethylene fiberbased composite film) from A.L.P lighting Components, Inc. of Niles, Ill., USA. As indicated in FIG. 1, a circular disc 32 of the material can be used to cover the face of the MCPCB 26 and a strip of the light reflective material configured as a cylindrical sleeve 34 that is inserted in the housing and is configured to cover the inner surface of the housing wall portion 16.

The device 10 further comprises a wavelength conversion component 36 that is operable to absorb a proportion of the blue light 28 (λ₁) generated by the LEDs 24 and convert it to light of a different wavelength (λ₂) by a process of photoluminescence. The emission product 40 of the device 10 comprises the combined light of wavelengths λ₁, λ₂ generated by the LEDs 24 and the wavelength conversion component 36. The wavelength conversion component is positioned remotely to the LEDs 24 and is spatially separated from the LEDs 24 a distance d that is typically at least 1 cm. In this patent specification, “remotely” and “remote” means in a spaced or separated relationship. The wavelength conversion component 36 is configured to completely cover the housing 12 opening such that all light emitted by the LEDs 24 passes through the component 36. As shown, the wavelength conversion component 36 can be detachably mounted to the top of the wall portion 16 using the top 18 enabling the component 36 and emission color of the lamp to be readily changed.

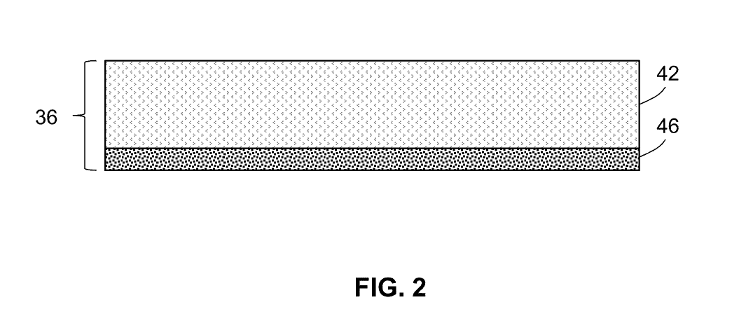

A typical wavelength conversion component 36 is illustrated in the cross-sectional view of FIG. 2. The typical wavelength conversion component 36 comprises a light transmissive substrate 42 and a wavelength conversion layer 46. The wavelength conversion layer may contain a mixture of one or more photo-luminescent (e.g., phosphor) materials in a carrier material. The light transmissive substrate 42 must be substantially transmissive to light in a wavelength range 380 nm to 740 nm and typically comprises a light transmissive polymer such as polycarbonate or acrylic or a glass such as a borosilicate glass (all of which are insulating materials).

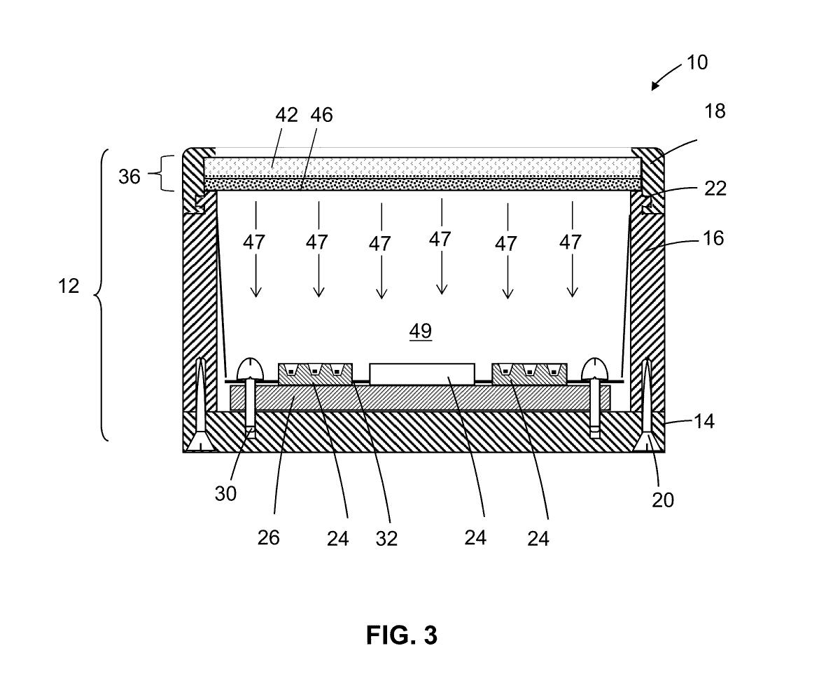

While the typical wavelength conversion component 36 provides adequate light conversion functionality, it suffers from an inability to properly dissipate heat. FIG. 3 illustrates a sectional view of the thermal characteristics of the device 10 of FIG. 1. During operation of the device 10, the LEDs 24 emit light that interacts with the wavelength conversion component 36 to generate light of a different wavelength to be emitted by the device 10. As the wavelength conversion layer 46 of the wavelength conversion component 36 absorbs light energy from the LEDs 24, it generates heat. This generated heat needs to be properly dissipated from the wavelength conversion layer 46, or else thermal degradation of the wavelength conversion layer 46 will occur which can result in a significant change in the characteristics of light emitted by the device 10. Such changes may include variations in the color of light emitted by the device 10 or variations in the intensity of light emitted. In many applications, these changes may be undesirable and may significantly affect performance.

The materials conventionally used for the light transmissive substrate 42 are all heat insulating materials. Heat insulating materials are characterized by their inability to provide efficient heat transfer to another material that it is in contact with. As such, the heat generated by the wavelength conversion layer 46 is unable to escape the device 10 into the exterior environment through the light transmissive substrate 42. Instead, the heat is either absorbed by the wavelength conversion layer 46 or dissipated back into the chamber of the device 10 as illustrated by arrows 47 in FIG. 3. Some of the heat dissipated back into the chamber 49 may be absorbed by the LEDs 24 and dissipated to the base 14 through thermal conduction. However, a significant portion of the heat remains trapped in the chamber 49 and continues to be re-absorbed by the wavelength conversion layer 46.

The wavelength conversion layer 46 may be able to withstand heat up to a certain threshold, but beyond that threshold, thermal degradation of the wavelength conversion layer 46 occurs. This is especially problematic in light emitting devices that call for a high intensity output (e.g., 500-600 lumens) for which a high input power (e.g., 6.5 W to 8 W) is required. In such high intensity light emitting devices, the wavelength conversion layer 46 may experience temperatures well above its threshold, ultimately resulting in thermal degradation of the wavelength conversion layer 46.

Thermal degradation of the wavelength conversion layer 46 can include both degradation of the optical properties of the wavelength conversion layer 46 and physical degradation of the wavelength conversion layer 46.

Degradation of optical properties refers to the wavelength conversion layer's ability to convert light generated by the LEDs 24 into light of a different wavelength. In some embodiments where the wavelength conversion layer 46 comprises a mixture of a phosphor material with a carrier material, optical properties of the wavelength conversion layer 46 may degrade at temperatures above the threshold. Such degradation of optical properties may include a decrease in efficiency of the wavelength conversion layer 46. Inefficiency may increase at high temperatures. At high temperatures, an increased amount of entropy is introduced into the wavelength conversion layer 46 causing the probability of a thermal event rather than a light emitting event to occur when light from the LEDs 24 is absorbed. The greater the temperature of the wavelength conversion layer 46, the greater the probability that a thermal event rather than a light emitting event will occur. The difference between room temperature and 100° C. may result, for example, in a 4% decline in efficiency, which is quite significant for many applications.

Physical degradation of the wavelength conversion layer 46 refers to the degradation of the structural integrity of the wavelength conversion layer 46. In some embodiments, a wavelength conversion layer 46 that rises above a temperature threshold may melt, resulting in the inoperability of the device.

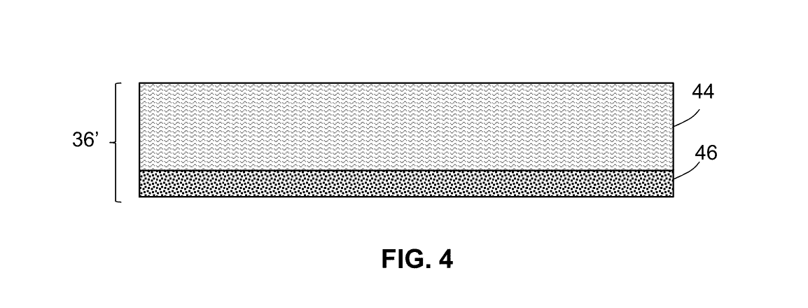

FIG. 4 illustrates a cross-sectional schematic of a wavelength conversion component 36′ in accordance with some embodiments. The wavelength conversion component 36′ comprises a light transmissive thermally conductive substrate 44 and a wavelength conversion layer 46. The wavelength conversion layer 46 is in thermal contact with the light transmissive thermally conductive substrate 44.

In some embodiments, the wavelength conversion layer 46 may be in thermal contact with the light transmissive thermally conductive substrate 44 by being in direct contact with the light transmissive thermally conductive substrate 44. The term “direct contact” means that there are no intervening layers or air gaps. In some other embodiments, the wavelength conversion layer 46 may be in thermal contact with the light transmissive thermally conductive substrate 44 by way of an optically transparent thermally conducting adhesive.

The light transmissive thermally conductive substrate 44 must be substantially transmissive to light in the visible spectrum (e.g., 380-740 nm). At such wavelengths, the light transmissive thermally conductive substrate 44 should ideally be able to transmit at least 90% of visible light. The light transmissive thermally conductive substrate 44 must also be thermally conductive. Thermally conductive substrates come in two forms: substrates that conduct heat through electron transport and substrates that conduct heat phononically. Some materials that conduct heat phononically due to their crystalline structure are also substantially transmissive to light in the visible spectrum. An example of a thermally conductive material that is substantially transmissive to light in the optical spectrum is sapphire.

The wavelength conversion layer 46 of the wavelength conversion component 36′ comprises a photo-luminescent material. In some embodiments, the wavelength conversion layer 46 may comprise a phosphor material mixed with a carrier material. In other embodiments, the wavelength conversion layer 46 may also include other photo-luminescent material such as quantum dots.

When the wavelength conversion layer 46 comprises a phosphor material mixed with a carrier material, the carrier material must be substantially transmissive to light in the visible spectrum (e.g., 380-740 nm). At such wavelengths, the carrier material should be able to transmit at least 90% of visible light. Such carrier materials may include a polymer resin, a monomer resin, an acrylic, an epoxy, a silicone, or a fluorinated polymer. In some embodiments the carrier material may be composed of a U.V. curable material. In some other embodiments, the carrier material may be composed of a thermally curable material.

When the wavelength conversion layer 46 comprises a phosphor mixed with a carrier material, the carrier material should have an index of refraction that is substantially similar to the index of refraction of the light transmissive thermally conductive substrate 44 in order to ensure proper transmission of light through the wavelength conversion component 36′. Additionally, when the wavelength conversion layer 46 comprises a phosphor material mixed with a carrier material, the carrier material should have a coefficient of thermal expansion that is substantially similar to the coefficient of thermal expansion of the light transmissive thermally conductive substrate 44 in order to preserve the structural integrity of the wavelength conversion component 36′.

For a wavelength conversion layer 46 comprising phosphor material mixed with a carrier material, the phosphor material can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors”, and U.S. Pat. No. 7,311,858 B2 “Silicate-based yellow-green phosphors”. The phosphor can also comprise an aluminate-based material such as is taught in co-pending patent application US2006/0158090 A1 “Novel aluminate-based green phosphors” and U.S. Pat. No. 7,390,437 B2 “Aluminate-based blue phosphors”, an aluminum-silicate phosphor as taught in co-pending application US2008/0111472 A1 “Aluminum-silicate orange-red phosphor” or a nitride-based red phosphor material such as is taught in co-pending United States patent application US2009/0283721 A1 “Nitride-based red phosphors” and International patent application WO2010/074963 A1 “Nitride-based red-emitting in RGB (red-green-blue) lighting systems”. It will be appreciated that the phosphor material is not limited to the examples described and can comprise any phosphor material including nitride and/or sulfate phosphor materials, oxy-nitrides and oxy-sulfate phosphors or garnet materials (YAG).

The wavelength conversion layer 46 may be deposited onto the light transmissive thermally conductive substrate 44 in any number of ways. In some embodiments, where the wavelength conversion layer 46 is a liquid mixture of phosphor material (in powder form) and carrier material (liquid form), the wavelength conversion layer 46 may be deposited by screen printing, though other printing or deposition techniques such as flexograph printing, gravure printing, pad printing, ink jet printing, slot die coating, spin coating, or doctor blading can be used.

By placing the wavelength conversion layer 46 in thermal contact with a light transmissive thermally conductive substrate 44, heat absorbed by the wavelength conversion layer 46 may be dissipated into the light transmissive thermally conductive substrate 44 by way of heat conduction, which may thereby conduct the heat into the exterior environment. Heat conduction refers to the transfer of energy between two objects that are in physical contact. Thus, the wavelength conversion layer 46 may be protected from thermal degradation (e.g., degradation of optical properties and physical degradation).

The rate of heat transfer that occurs between the wavelength conversion layer 46 and the light transmissive thermally conductive substrate 44 is directly proportional to the surface area of the interface between the wavelength conversion layer 46 and the light transmissive thermally conductive substrate 44 and indirectly proportional to the thickness of the light transmissive thermally conductive substrate 44. Thus, by increasing the surface area of the interface between the wavelength conversion layer 46 and the light transmissive thermally conductive substrate 44, the rate of heat transfer between the two layers may be increased. Similarly, by decreasing the thickness of the light transmissive thermally conductive substrate 44, the rate of heat transfer between the two layers may be increased. Thus the amount of heat dissipated from the wavelength conversion layer 46 into the light transmissive thermally conductive substrate 44 may be optimized by adjusting the dimensions of the light transmissive thermally conductive substrate 44.

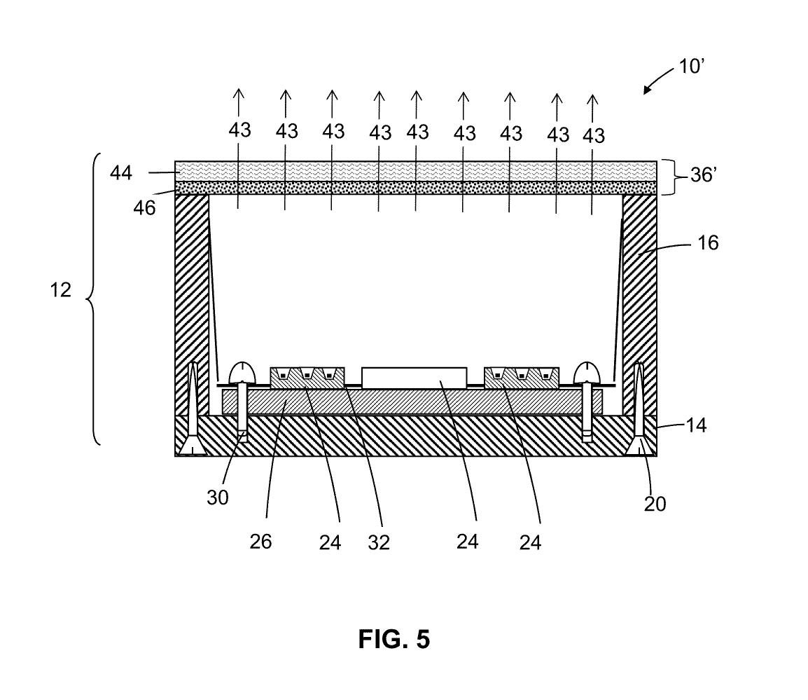

The wavelength conversion component of FIG. 4 may be implemented in a light emitting device in various different ways. FIG. 5 illustrates a cross-section of a light-emitting device 10′ comprising the wavelength conversion component 36′ in FIG. 4 in accordance with some embodiments. The wavelength conversion component 36′ may be placed directly above the wall portion 16 of the light emitting device 10′. During operation, the LEDs 24 emit light towards the wavelength conversion component 36′. The wavelength conversion layer 46 absorbs this light and converts it to light of another wavelength, as discussed above. As the wavelength conversion layer 46 of the wavelength conversion component 36′ absorbs light energy from the LEDs 24, it generates heat. The light transmissive thermally conductive substrate 44 is able to conduct the generated heat away from the wavelength conversion layer 46 into the exterior environment as illustrated by the arrows 43 in FIG. 5. By optimizing the conductive properties of the light transmissive thermally conductive substrate 44 (e.g., modifying dimensions), the wavelength conversion layer 46 may be configured to stay below a temperature threshold thereby ensuring that the wavelength conversion layer 46 is protected from thermal degradation (e.g., degradation of optical properties or physical degradation).

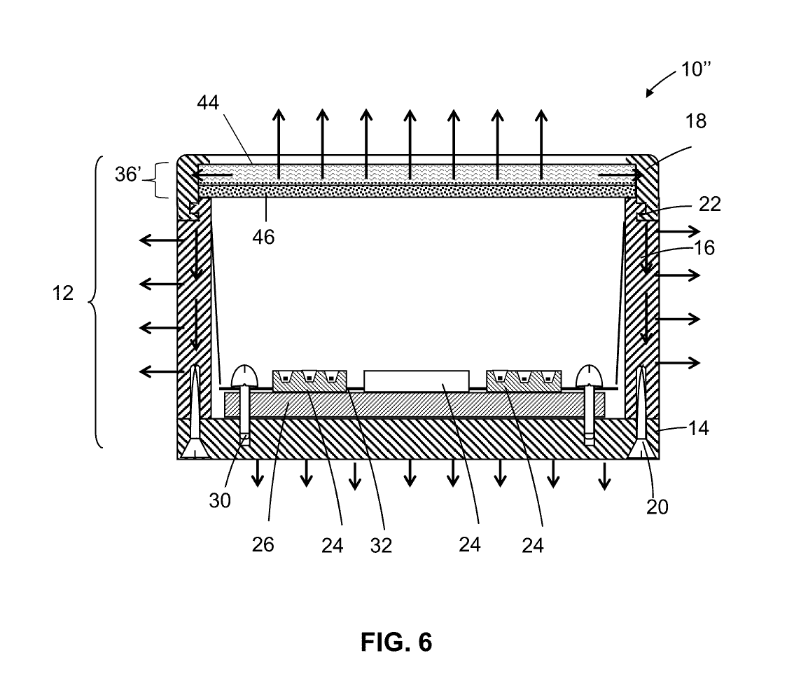

FIG. 6 illustrates a cross-section of a light-emitting device 10″ comprising the wavelength conversion component 36′ in FIG. 4 in accordance with some other embodiments. In some embodiments the wavelength conversion component 36′ may be placed directly above the wall portion 16 of the light emitting device 10″ with the substrate 44 in thermal contact with a heat sink 18 (e.g. annular top). The heat sink 18 may be composed of heat conducting material such as aluminum, an alloy of aluminum or any material with a high thermal conductivity (preferably ≧200 Wm⁻¹k⁻¹) such as for example copper, a magnesium alloy, or a conductive plastic compositions with thermally conductive additives (e.g., metal, graphite particles, carbon nanotubes). In some embodiments the heat sink 18 may be part of the thermally conductive structure (e.g., cylindrical body 12) used to conduct heat away from the LEDs 24. In such embodiments, the light emitting device 10″ is able to use its existing structure to provide thermal conduction to the wavelength conversion component 36′ without having to introduce additional components to the device 10″. In other embodiments, an independent heat sink may be provided for the wavelength conversion component 36′ that is separate from the heat sink for the LEDs 24.

During operation, the LEDs 24 emit light towards the wavelength conversion component 36′. The wavelength conversion layer 46 absorbs this light and converts it to light of another wavelength, as discussed above. As the wavelength conversion layer 46 of the wavelength conversion component 36′ absorbs light energy from the LEDs 24, it generates heat. The light transmissive thermally conductive substrate 44 is able to conduct the generated heat away from the wavelength conversion layer 46 into the exterior environment as illustrated by the arrows in FIG. 5. The light transmissive thermally conductive substrate 44 is also able to conduct the generated heat away from the wavelength conversion layer 46 into the heat sink 18 (e.g., detachable annular top) due to the light transmissive thermally conductive substrate 44 being in thermal contact with the heat sink 18 as illustrated by the arrows. The heat sink 18 may then dissipate heat into the external environment as illustrated by the arrows.

By providing a heat sink 18 in thermal contact with the wavelength conversion component 36′, additional exit paths for heat absorbed by the wavelength conversion layer 46 are made available. This increases the heat dissipating efficiency of the wavelength conversion component 36′. By optimizing the conductive properties of the light transmissive thermally conductive substrate 44 (e.g., dimensions) as well as the conductive properties of the heat sink 18 (e.g., dimensions/materials), the wavelength conversion layer 46 may be configured to stay below a temperature threshold thereby ensuring that the wavelength conversion layer 46 is protected from thermal degradation (e.g., degradation of optical properties or physical degradation).

While the wavelength conversion component 36′ of FIG. 4 is illustrated as being configured such that the wavelength conversion layer 46 faces the LEDs 24, in some other embodiments the wavelength conversion component 36′ may be configured such that the light transmissive thermally conductive substrate 44 faces the LEDs 24. For example, if the LEDs 24 are high powered (e.g., generated high temperatures), it may be preferred to configure the light transmissive thermally conductive substrate 44 to face the LEDs in order to provide greater thermal protection to the wavelength conversion layer 46.

The wavelength conversion components described above have two-dimensional configurations (e.g., planar surface). In other embodiments, it is possible for the wavelength conversion component to have a three-dimensional configuration for different applications.

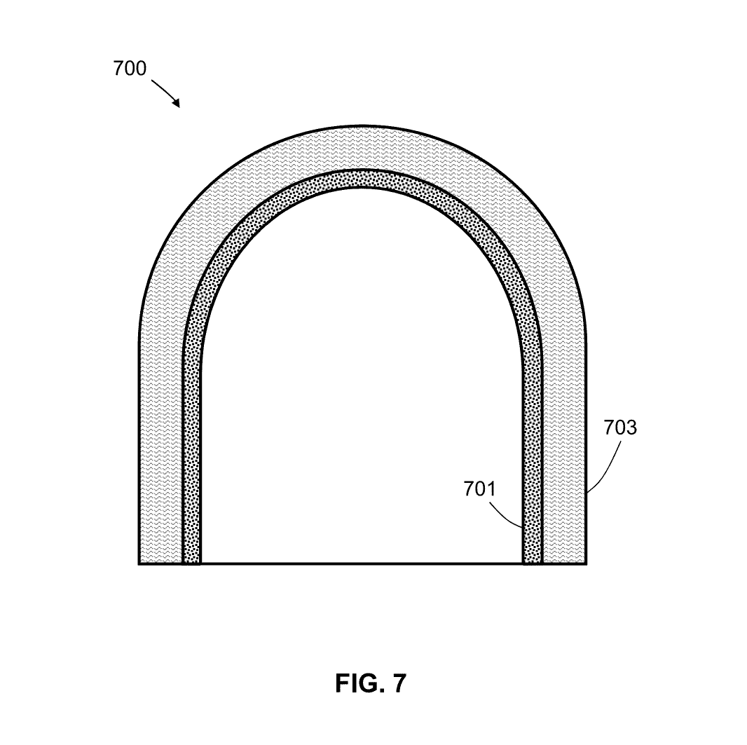

FIG. 7 illustrates a cross-sectional view of a wavelength conversion component 700 in accordance with some embodiments. The wavelength conversion component 700 of FIG. 7 is a three-dimensional configuration of the wavelength conversion component 36′ of FIG. 4. For purposes of discussion, only features of the wavelength conversion component 700 of FIG. 7 that are new relative to the embodiments of FIG. 4 will be described.

Whereas the wavelength conversion component 36′ in FIG. 4 has a two-dimensional shape (e.g., is substantially planar), the wavelength conversion component 700 of FIG. 7 has a three-dimensional shape (e.g., elongated dome shaped and/or ellipsoidal shell). The three-dimensional wavelength conversion component 700 in FIG. 7 includes a three-dimensional wavelength conversion layer 701 and a three-dimensional light transmissive thermally conductive substrate 703 rather than a planar first wavelength conversion layer and a planar light transmissive thermally conductive substrate. Configuring the wavelength conversion component 700 as a three-dimensional shape may be useful for applications where it is necessary for light emitted from the light emitting device to be spread over a larger solid angle.

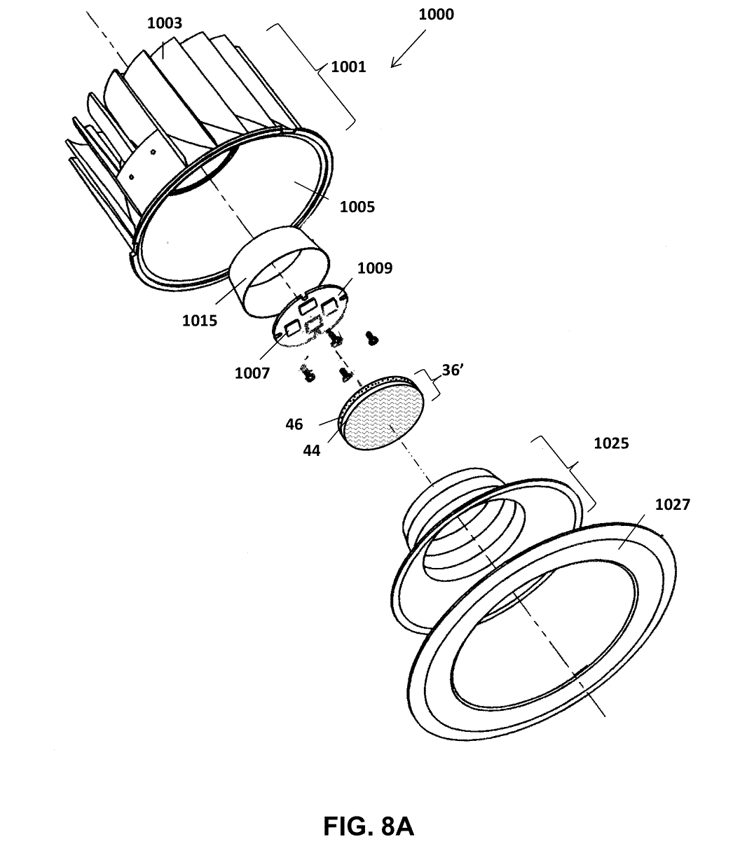

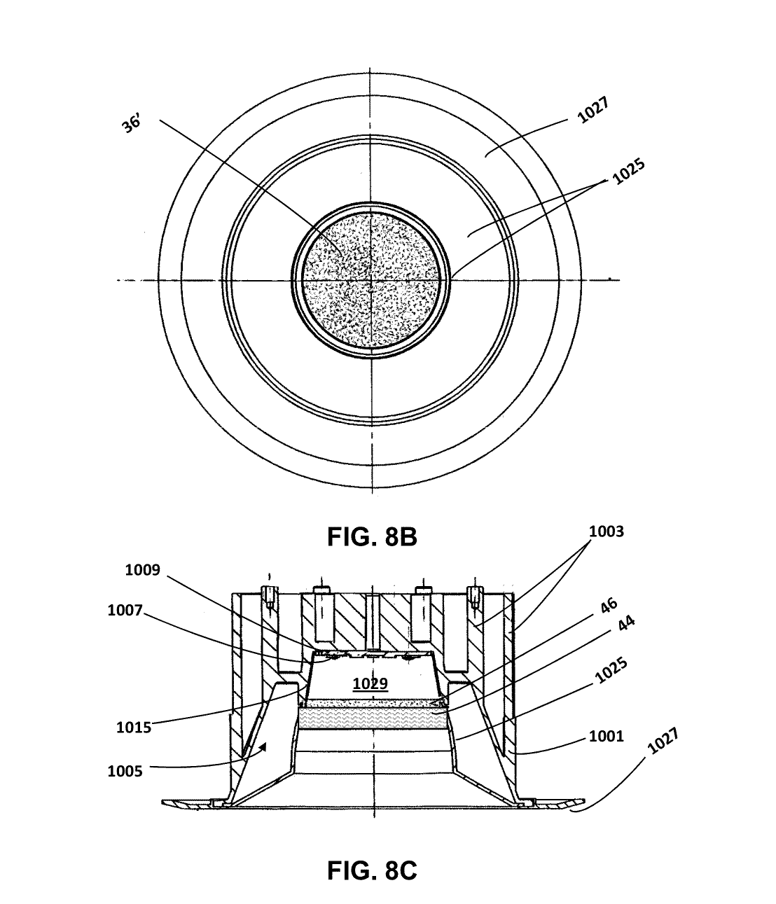

FIGS. 8A, 8B, and 8C illustrate an example of an application of a wavelength conversion component in accordance with some embodiments of the invention. FIGS. 8A, 8B, and 8C illustrates an LED downlight 1000 that utilizes remote wavelength conversion in accordance with some embodiments. FIG. 8A is an exploded perspective view of the LED downlight 1000, FIG. 8B is an end view of the downlight 1000, and FIG. 8C is a sectional view of the downlight 1000. The downlight 1000 is configured to generate light with an emission intensity of 650-700 lumens and a nominal beam spread of 60° (wide flood). It is intended to be used as an energy efficient replacement for a conventional incandescent six inch downlight.

The downlight 1000 comprises a hollow generally cylindrical thermally conductive body 1001 fabricated from, for example, die cast aluminum. The body 1001 functions as a heat sink and dissipates heat generated by the light emitters 1007. To increase heat radiation from the downlight 1000 and thereby increase cooling of the downlight 1000, the body 1001 can include a series of latitudinal spirally extending heat radiating fins 1003 located towards the base of the body 1001. To further increase the radiation of heat, the outer surface of the body can be treated to increase its emissivity such as for example painted black or anodized. The body 1001 further comprises a generally frustoconical (i.e. a cone whose apex is truncated by a plane that is parallel to the base) axial chamber 1005 that extends from the front of the body a depth of approximately two thirds of the length of the body. The form factor of the body 1001 is configured to enable the downlight to be retrofitted directly in a standard six inch downlighting fixture (can) as are commonly used in the United States.

Four solid state light emitters 1007 are mounted as a square array on a circular shaped MCPCB (Metal Core Printed Circuit Board) 1009. As is known an MCPCB comprises a layered structure composed of a metal core base, typically aluminum, a thermally conducting/electrically insulating dielectric layer and a copper circuit layer for electrically connecting electrical components in a desired circuit configuration. With the aid of a thermally conducting compound such as for example a standard heat sink compound containing beryllium oxide or aluminum nitride the metal core base of the MCPCB 1009 is mounted in thermal communication with the body via the floor of the chamber 1005. As shown in FIG. 5 the MCPCB 1009 can be mechanically fixed to the body floor by one or more screws, bolts or other mechanical fasteners.

The downlight 1000 further comprises a hollow generally cylindrical light reflective chamber wall mask 1015 that surrounds the array of light emitters 1007. The chamber wall mask 1015 can be made of a plastics material and preferably has a white or other light reflective finish. A wavelength conversion component 36′, such as the one described above in FIG. 4, may be mounted overlying the front of the chamber wall mask 1015 using, for example, an annular steel clip that has resiliently deformable barbs that engage in corresponding apertures in the body. The wavelength conversion component 36′ is remote to the light emitting devices 1007.

The wavelength conversion component 36′ comprises a light transmissive thermally conductive substrate 44 in thermal contact with a wavelength conversion layer 46 as described above. By placing the wavelength conversion layer 46 in thermal contact with a light transmissive thermally conductive substrate 44, heat absorbed by the wavelength conversion layer 46 may be dissipated into the light transmissive thermally conductive substrate 44 by way of heat conduction, which may thereby conduct the heat into the exterior environment. Thus, the wavelength conversion layer 46 is protected from thermal degradation (e.g., degradation of optical properties and physical degradation).

The light transmissive thermally conductive substrate 44 may also be in thermal contact with the body 1001. The light transmissive thermally conductive substrate 44 may then be able to conduct generated heat away from the wavelength conversion layer 46 into the body 1001 due to the light transmissive thermally conductive substrate 44 being in thermal contact with the heat sink. The body 1001 may then dissipate heat into the external environment. By providing a heat sink in thermal contact with the light transmissive thermally conductive substrate 44, additional thermally conductive paths for heat absorbed by the wavelength conversion layer 46 are made available. This increases the heat dissipating efficiency of the wavelength conversion component 36′.

The downlight 1000 further comprises a light reflective hood 1025 which is configured to define the selected emission angle (beam spread) of the downlight (i.e. 60° in this example). The hood 1025 comprises a generally cylindrical shell with three contiguous (conjoint) inner light reflective frustoconical surfaces. The hood 1025 is preferably made of Acrylonitrile butadiene styrene (ABS) with a metallization layer. Finally the downlight 1000 can comprise an annular trim (bezel) 1027 that can also be fabricated from ABS.

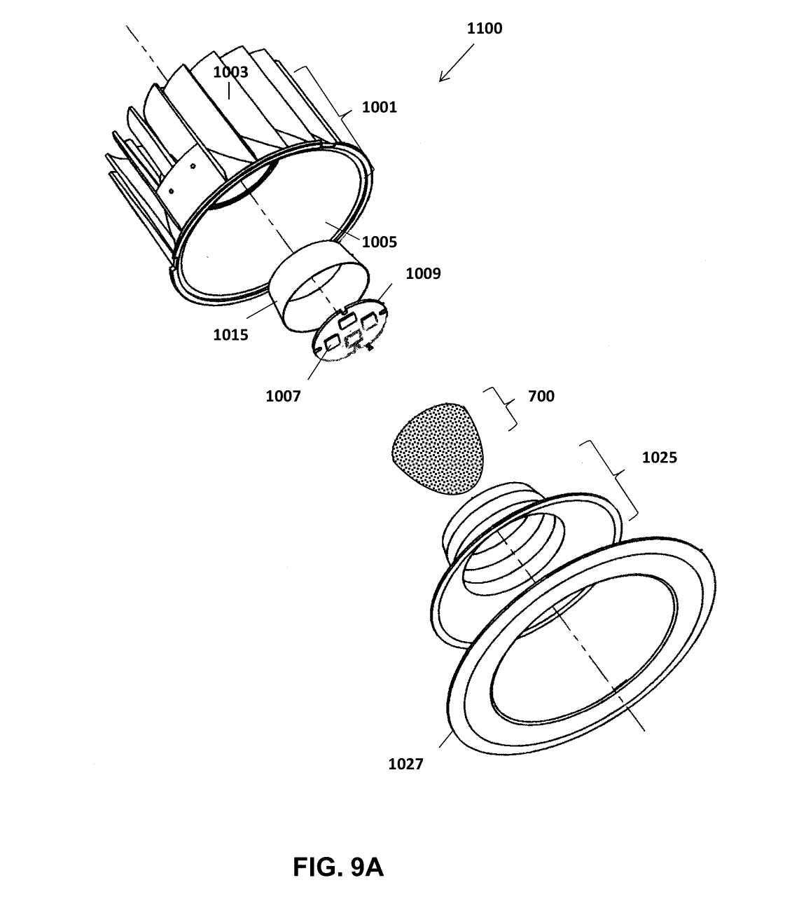

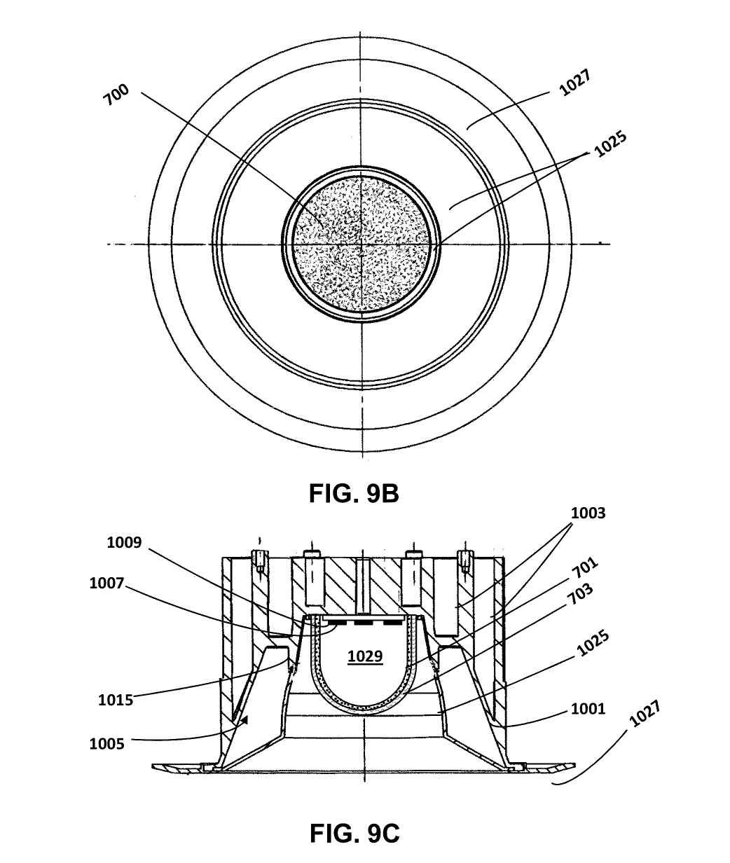

FIGS. 9A, 9B, and 9C illustrate another example of an application of a wavelength conversion component in accordance with some embodiments. FIGS. 9A, 9B, and 9C illustrate an LED downlight 1100 that utilizes remote wavelength conversion in accordance with some embodiments. FIG. 9A is an exploded perspective view of the LED downlight 1100, FIG. 9B is an end view of the downlight 1100, and FIG. 9C is a sectional view of the downlight 1100. The downlight 1100 is configured to generate light with an emission intensity of 650-700 lumens and a nominal beam spread of 60° (wide flood). It is intended to be used as an energy efficient replacement for a conventional incandescent six inch downlight.

The downlight 1100 of FIGS. 9A, 9B, and 9C is substantially the same as the downlight 1000 of FIGS. 8A, 8B, and 8C. For purposes of discussion, only features of the downlight 1100 that are new relative to the embodiments of FIGS. 8A, 8B, and 8C will be described.

Whereas the wavelength conversion component 36′ of FIGS. 8A, 8B, and 8C has a two-dimensional shape (e.g., is substantially planar), the wavelength conversion component 700 of FIGS. 9A, 9B, and 9C has a three-dimensional shape (e.g., elongated dome shaped and/or ellipsoidal shell). The three dimensional wavelength conversion component 700 includes a three-dimensional light transmissive thermally conductive substrate 703 in thermal contact with a three-dimensional wavelength conversion layer 701, such as the wavelength conversion component 700 described above in FIG. 7. The wavelength conversion component may also be mounted enclosing the front of the chamber wall mask 1015.

As discussed above, by placing the wavelength conversion layer 701 in thermal contact with a light transmissive thermally conductive substrate 703, heat absorbed by the wavelength conversion layer 701 may be dissipated into the light transmissive thermally conductive substrate 703 by way of heat conduction, which may thereby conduct the heat into the exterior environment. Thus, the wavelength conversion layer 701 may be protected from thermal degradation (e.g., degradation of optical properties and physical degradation).

The light transmissive thermally conductive substrate 703 may also be in thermal contact with the body 1001. The light transmissive thermally conductive substrate 703 may then be able to conduct generated heat away from the wavelength conversion layer 701 into the heat sink 1001 due to the light transmissive thermally conductive substrate 703 being in thermal contact with the body 1001. The body 1001 may then dissipate heat into the external environment. By providing a heat sink in thermal contact with the light transmissive thermally conductive substrate 703, additional thermally conductive paths for heat absorbed by the wavelength conversion layer 701 are made available. This increases the heat dissipating efficiency of the wavelength conversion component 700.

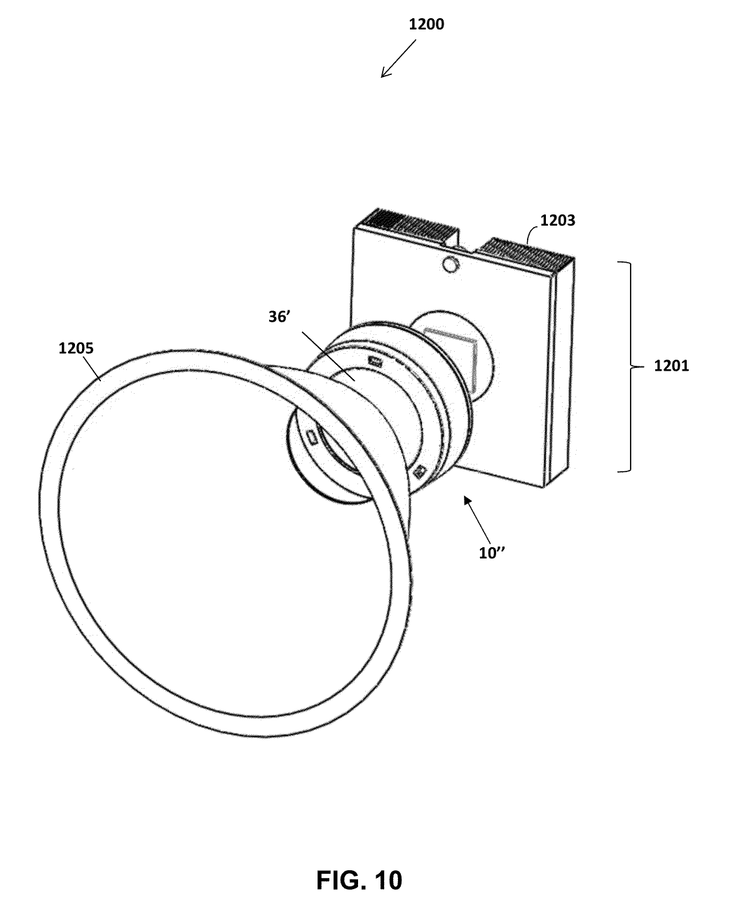

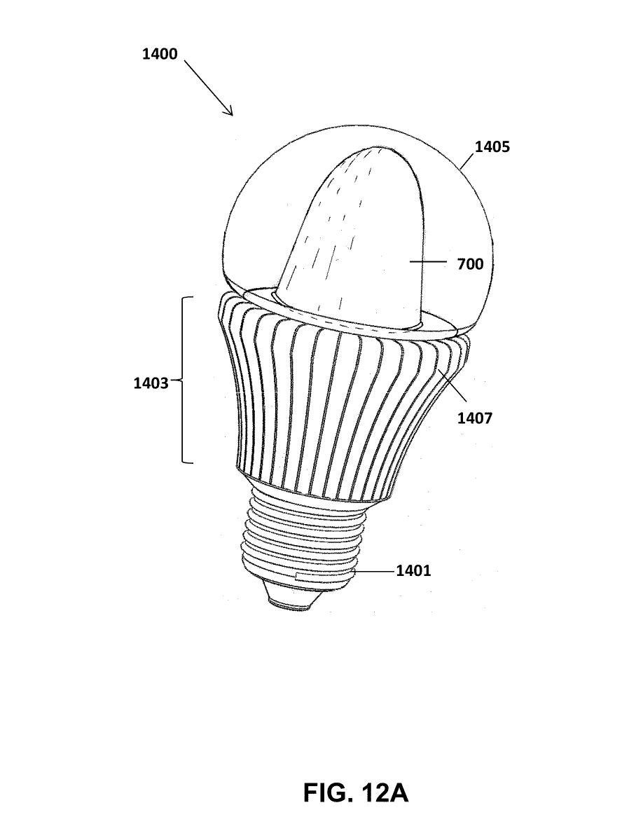

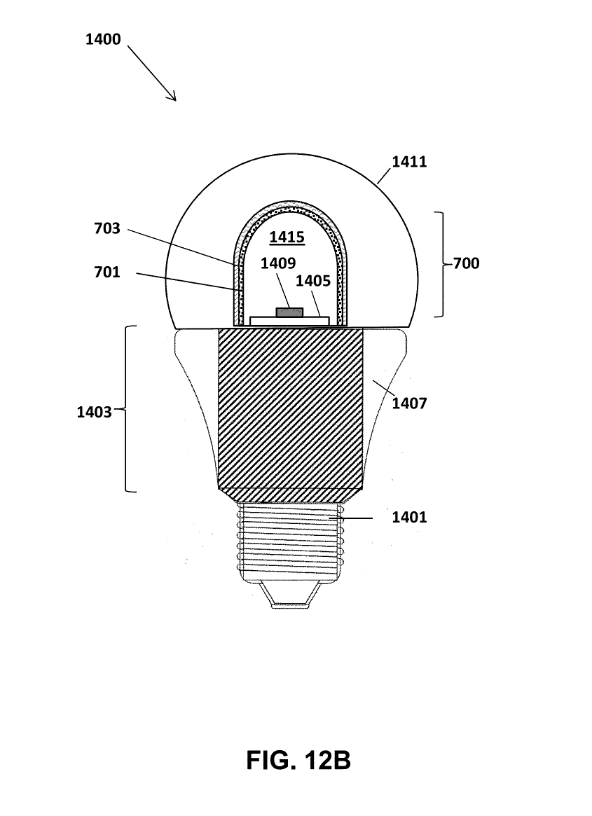

FIG. 10 illustrates another example of an application of a wavelength conversion component in accordance with some embodiments. FIG. 12 illustrates an exploded perspective view of a reflector lamp 1200 that utilizes remote wavelength conversion in accordance with some embodiments. The reflector lamp 1200 is configured to generate light with an emission intensity of 650-700 lumens and a nominal beam spread of 60° (wide flood). It is intended to be used as an energy efficient replacement for a conventional incandescent six inch downlight.

The reflector lamp 1200 comprises a generally rectangular thermally conductive body 1201 fabricated from, for example, die cast aluminum. The body 1201 functions as a heat sink and dissipates heat generated by the light emitting device 10″, such as the one described above in FIG. 6. To increase heat radiation from the reflector lamp 1200 and thereby increase cooling of the light emitting device 10″, the body 1201 can include a series of heat radiating fins 1203 located on the sides of the body 1201. To further increase the radiation of heat, the outer surface of the body 1201 can be treated to increase its emissivity such as for example painted black or anodized. The body 1201 further comprises a thermally conductive pad that may be placed in contact with a thermally conductive base of the light emitting device 10″. The form factor of the body 1201 is configured to enable the reflector lamp 1200 to be retrofitted directly in a standard six inch downlighting fixture (a “can”) as are commonly used in the United States.

A light emitting device 10″ that includes a wavelength conversion component 36′ such as the one described above with respect to FIG. 4 may be attached to the body 1201 such that the thermally conductive base of the light emitting device 10″ may be in thermal contact with the thermally conductive pad of the body 1201. The light emitting device 10″ may include a hollow cylindrical body with a base and sidewalls that is substantially the same as the cylindrical body described in FIG. 6 that is configured to house the wavelength conversion component 36′.

The wavelength conversion component 36′ may be configured to dissipate heat into the exterior environment via a light transmissive thermally conductive substrate (not shown), as described above with respect to FIG. 6. The body of the light emitting device 10″ may also be a heat sink that is in thermal contact with the light transmissive thermally conductive substrate of the wavelength conversion component 36′. The body of the light emitting device 10″ may then dissipate heat into the external environment or into the body 1201 of the reflector lamp 1200. Thus, additional thermally conductive paths for heat absorbed by the wavelength conversion layer are made available. This increases the heat dissipating efficiency of the wavelength conversion component 36″.

The reflector lamp 1200 further comprises a generally frustroconical light reflector 1205 having a paraboloidal light reflective inner surface which is configured to define the selected emission angle (beam spread) of the downlight (i.e. 60° in this example). The reflector 1205 is preferably made of Acrylonitrile butadiene styrene (ABS) with a metallization layer.

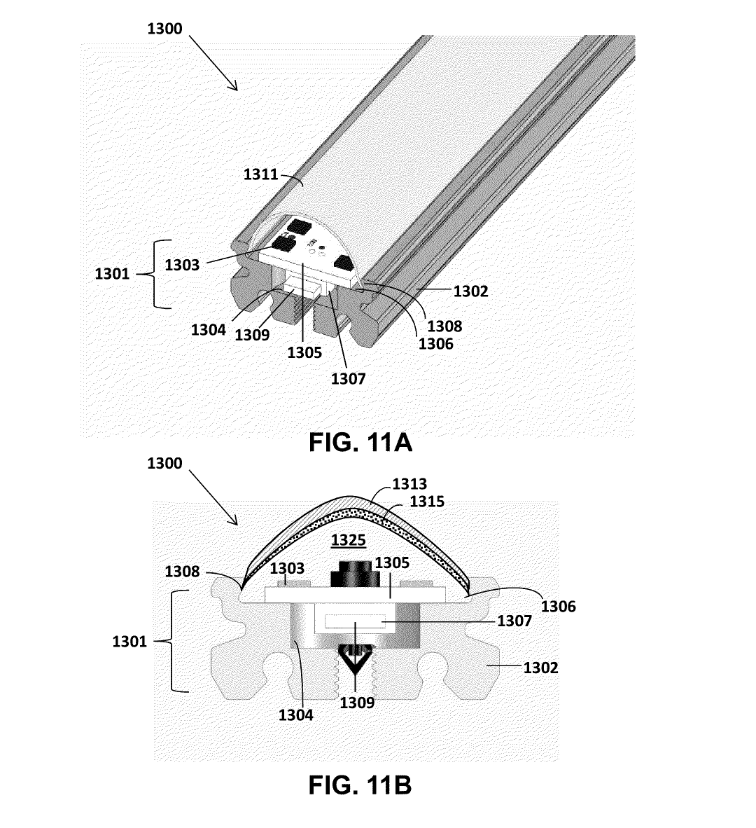

FIGS. 11A and 11B illustrate another example of an application of a wavelength conversion component in accordance with some embodiments. FIGS. 11A and 11B illustrate an LED linear lamp 1300 that utilizes remote wavelength conversion in accordance with some embodiments. FIG. 11A is a three-dimensional perspective view of the linear lamp 1300 and FIG. 11B is a cross-sectional view of the linear lamp 1300. The LED linear lamp 1300 is intended to be used as an energy efficient replacement for a conventional incandescent or fluorescent tube lamp.

The linear lamp 1300 comprises an elongated thermally conductive body 1301 fabricated from, for example, extruded aluminum. The form factor of the body 1301 can be configured to be mounted with a standard linear lamp housing. The body 1301 further comprises a first recessed channel 1304, wherein a rectangular tube-like case 1307 containing some electrical components (e.g., electrical wires) of the linear lamp 1300 may be situated. The case 1307 may further comprise an electrical connector 1309 (e.g., plug) extending past the length of the body 1301 on one end, and a recessed complimentary socket (not shown) configured to receive a connector on another end. This allows several linear lamps 1300 to be connected in series to cover a desired area. Individual linear lamps 1300 may range from 1 foot to 6 feet in length.

The body 1301 functions as a heat sink and dissipates heat generated by the light emitters 1303. To increase heat radiation from the linear lamp 1300 and thereby increase cooling of the light emitters 1303, the body 1301 can include a series of heat radiating fins 1302 located on the sides of the body 1301. To further increase heat radiation from the linear lamp 1300, the outer surface of the body 1301 can be treated to increase its emissivity such as for example painted black or anodized.

Light emitters 1303 are mounted on a strip (rectangular shaped) MCPCB (Metal Core Printed Circuit Board) 1305 configured to sit above the first recessed channel 1304. The under surface of the MCPCB 1305 sits in thermal contact with a second recessed channel 1306 that includes inclined walls 1308.

A generally hemi-spherical elongate wavelength conversion component 1311 may be positioned remote to the light emitters 1303. The wavelength conversion component 1311 may be secured within the second recessed channel 1306 by sliding the wavelength conversion component 1311 under the inclined walls 1308 such that the wavelength conversion component 1311 engages with inclined walls 1308.

The wavelength conversion component 1311 may include a hemi-spherical elongate light transmissive thermally conductive substrate 1313 and a hemi-spherical elongate wavelength conversion layer 1315. As discussed above, by placing the wavelength conversion layer 1315 in thermal contact with a light transmissive thermally conductive substrate 1313, heat absorbed by the wavelength conversion layer 1315 may be dissipated into the light transmissive thermally conductive substrate 1313 by way of heat conduction, which may thereby conduct the heat into the exterior environment. Thus, the wavelength conversion layer 1315 may be protected from thermal degradation (e.g., degradation of optical properties and physical degradation).

The light transmissive thermally conductive substrate 1313 may also be in thermal contact with the body 1301. The light transmissive thermally conductive substrate 1313 may then be able to conduct generated heat away from the wavelength conversion layer 1315 into the heat sink 1301 due to the light transmissive thermally conductive substrate 1313 being in thermal contact with the body 1301. The body 1301 may then dissipate heat into the external environment. By providing a heat sink in thermal contact with the light transmissive thermally conductive substrate 1313, additional thermally conductive paths for heat absorbed by the wavelength conversion layer 1315 are made available. This increases the heat dissipating efficiency of the wavelength conversion component 1315.

In alternative embodiments, the wavelength conversion component of the linear lamp may be configured in the shape of a generally planar strip. In such embodiments, it will be appreciated that the second recessed channel may instead have vertical walls that extend to allow the wavelength conversion component to be received by the second recessed channel.

FIGS. 12A and 12B illustrate a perspective view and a cross-sectional view of an application of a wavelength conversion component in accordance with some embodiments.

FIGS. 12A and 12B illustrate an LED light bulb that utilizes remote wavelength conversion. The LED light bulb 1400 is intended to be used as an energy efficient replacement for a conventional incandescent or fluorescent light bulb.

The light bulb 1400 comprises a screw base 1401 that is configured to fit within standard light bulb sockets, e.g. implemented as a standard Edison screw base. The light bulb 1400 may further comprise a thermally conductive body 1403 fabricated from, for example, die cast aluminum. The body 1403 functions as a heat sink and dissipates heat generated by the light emitters 1409, which are mounted on a MCPCB 1405 (Metal Core Printed Circuit Board). The MCPCB 1405 may be in thermal contact with the body 1403. To increase heat radiation from the light bulb 1400 and thereby increase cooling of the light bulb 1400, the body 1403 can include a series of latitudinal radially extending heat radiating fins 1407. To further increase the radiation of heat, the outer surface of the body 1403 can be treated to increase its emissivity such as for example painted black or anodized.

The light bulb 1400 further comprises a wavelength conversion component 700, such as the one described above in FIG. 7, having a three-dimensional shape (e.g., elongated dome shaped and/or ellipsoidal shell) that encloses the light emitters 1409. The three dimensional wavelength conversion component 700 includes a three-dimensional light transmissive thermally conductive substrate 703 in thermal contact with a three-dimensional wavelength conversion layer 701.

As discussed above, by placing the wavelength conversion layer 701 in thermal contact with a light transmissive thermally conductive substrate 703, heat absorbed by the wavelength conversion layer 701 may be dissipated into the light transmissive thermally conductive substrate 703 by way of heat conduction, which may thereby conduct the heat into the exterior environment. Thus, the wavelength conversion layer 701 may be protected from thermal degradation (e.g., degradation of optical properties and physical degradation).

The light transmissive thermally conductive substrate 703 may also be in thermal contact with the body 1403. The light transmissive thermally conductive substrate 703 may then be able to conduct generated heat away from the wavelength conversion layer 701 into the heat sink 1403 due to the light transmissive thermally conductive substrate 703 being in thermal contact with the body 1403. The body 1403 may then dissipate heat into the external environment. By providing a heat sink 1403 in thermal contact with the light transmissive thermally conductive substrate 703, additional thermally conductive paths for heat absorbed by the wavelength conversion layer 701 are made available. This increases the heat dissipating efficiency of the wavelength conversion component 700.

An envelope 1411 may extend around the upper portion of the LED light bulb 1400, enclosing the LEDs 1409 and the wavelength conversion component 700. The envelope 1411 is a light-transmissive material (e.g. glass or plastic) that provides protective and/or diffusive properties for the LED light bulb 1400.

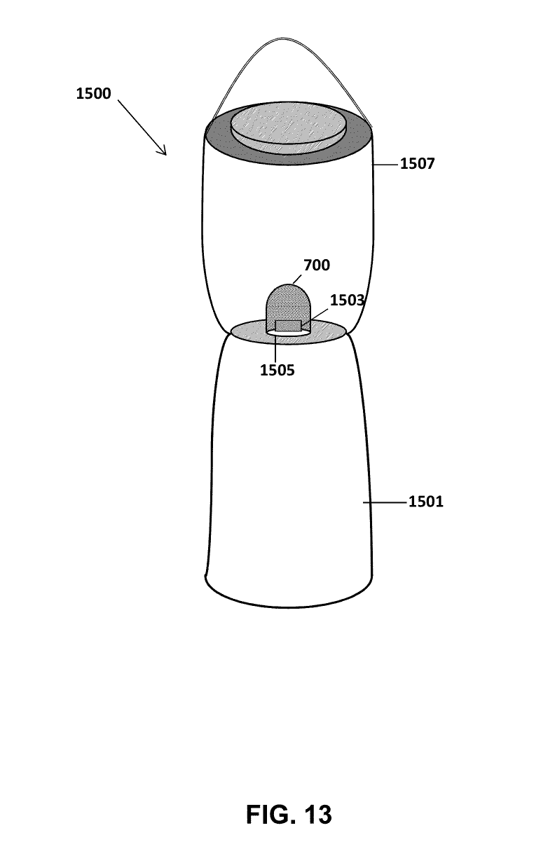

FIG. 13 illustrates a perspective of another application of a wavelength conversion component in accordance with some embodiments. FIG. 13 illustrates an LED lantern 1500 that utilizes remote wavelength conversion. The LED light lantern 1500 is intended to be used as an energy efficient replacement for conventional gas and fluorescent lanterns (e.g., camping lanterns).

The lantern 1500 comprises a generally cylindrical thermally conductive body 1501 fabricated from, for example, plastic material or pressed metal. The body 1501 further includes an internal heat sink which dissipates heat generated by the light emitters 1503, which are mounted on a circular shaped MCPCB 1505. The MCPCB 1505 may be in thermal contact with the body 1501.

The lantern 1500 comprises a three-dimensional (e.g., elongated dome shaped and/or ellipsoidal shell) wavelength conversion component 700, such as the one described above in FIG. 7, that extends from the MCPCB 1505. While only an exterior surface of the wavelength conversion component 700 is depicted, it is important to note that the three dimensional wavelength conversion component 700 may include a three-dimensional light transmissive thermally conductive substrate in thermal contact with a three-dimensional wavelength conversion layer.

As discussed above, by placing the wavelength conversion layer in thermal contact with a light transmissive thermally conductive substrate, heat absorbed by the wavelength conversion layer may be dissipated into the light transmissive thermally conductive substrate by way of heat conduction, which may thereby conduct the heat into the exterior environment. Thus, the wavelength conversion layer may be protected from thermal degradation (e.g., degradation of optical properties and physical degradation).

The light transmissive thermally conductive substrate may also be in thermal contact with the internal heat sink. The light transmissive thermally conductive substrate may then be able to conduct generated heat away from the wavelength conversion layer into the internal heat sink due to the light transmissive thermally conductive substrate being in thermal contact with the internal heat sink. The internal heat sink may then dissipate heat into the external environment. By providing a heat sink in thermal contact with the wavelength conversion component, additional thermally conductive paths for heat absorbed by the wavelength conversion layer are made available. This increases the heat dissipating efficiency of the wavelength conversion component 700.

A light transmissive cover (e.g., plastic) 1507 may extend around the upper portion of the lantern, surrounding the LEDs 1503 and the wavelength conversion component 700. The light transmissive cover 1507 comprises a light-transmissive material (e.g. glass or plastic) that provides protective and/or diffusive properties for the LED lantern 1500. The lantern 1500 may further comprise a lid that sits on top of the glass receptacle to enclose the light emitters 1503 and the wavelength conversion component 700.

The above applications of light emitting devices describe a remote wavelength conversion configuration, wherein a wavelength conversion component is remote to one or more light emitters. The wavelength conversion component and body of those light emitting devices define an interior volume wherein the light emitters are located. The interior volume may also be referred to as a light mixing chamber. For example, in the downlight 1000, 1100 of FIGS. 8A, 8B, 8C, 9A, 9B, and 9C, an interior volume 1029 is defined by the wavelength conversion component 36′, 700, the light reflective chamber mask 1015, and the body of the downlight 1001. In the linear lamp 1300 of FIGS. 11A and 11B, an interior volume 1325 is defined by the wavelength conversion component 1311 and the body of the linear lamp 1301. In the light bulb 1400 of FIGS. 12A and 12B, an interior volume 1415 is defined by the wavelength conversion component 700 and the body of the light bulb 1407. Such an interior volume provides a physical separation (air gap) of the wavelength conversion component from the light emitters that improves the thermal characteristics of the light emitting device. Due to the isotropic nature of photoluminescence light generation, approximately half of the light generated by the phosphor material can be emitted in a direction towards the light emitters and can end up in the light mixing chamber. It is believed that on average as little as 1 in a 10,000 interactions of a photon with a phosphor material particle results in absorption and generation of photoluminescence light. The majority, about 99.99%, of interactions of photons with a phosphor particle result in scattering of the photon. Due to the isotropic nature of the scattering process on average half the scattered photons will be in a direction back towards the light emitters. As a result up to half of the light generated by the light emitters that is not absorbed by the phosphor material can also end up back in the light mixing chamber. To maximize light emission from the device and to improve the overall efficiency of the light emitting device the interior volume of the mixing chamber includes light reflective surfaces to redirect—light in—the interior volume towards the wavelength conversion component and out of the device. The light mixing chamber may also operate to mix light within the chamber. The light mixing chamber can be defined by the wavelength conversion component in conjunction with another component of the device such a device body or housing (e.g., dome-shaped wavelength conversion component encloses light emitters located on a base of device body to define light mixing chamber, or planar wavelength conversion component placed on a chamber shaped component to enclose light emitters located on a base of device body and surrounded by the chamber shaped component to define light mixing chamber). For example, the downlight 1000, 1100 of FIGS. 8A, 8B, 8C, 9A, 9B, and 9C, includes an MCPCB 1009, on which the light emitters 1007 are mounted, comprising light reflective material and a light reflective chamber wall mask 1015 to facilitate the redirection of light reflected back into the interior volume towards the wavelength conversion component 36′, 700. The linear lamp 1300 of FIGS. 11A and 11B includes an MCPCB 1305, on which the light emitters 1303 are mounted, comprising light reflective material to facilitate the redirection of light reflected back into the interior volume towards the wavelength conversion component 1311. The light bulb 1400 of FIGS. 12A and 12B also includes an MCPCB 1405, on which the light emitters 1409 are mounted, to facilitate the redirection of light reflected back into the interior volume towards the wavelength conversion component 700.

The above applications of light emitting devices describe only a few embodiments with which the claimed invention may be applied. It is important to note that the claimed invention may be applied to other types of light emitting device applications, including but not limited to, wall lamps, pendant lamps, chandeliers, recessed lights, track lights, accent lights, stage lighting, movie lighting, street lights, flood lights, beacon lights, security lights, traffic lights, headlamps, taillights, signs, etc.

Therefore, what has been described is a wavelength conversion component with improved thermal conductive characteristics for remote wavelength conversion. The improved wavelength conversion component comprises a light transmissive thermally conductive substrate in thermal contact with a surface of a wavelength conversion layer. By providing a light transmissive thermally conductive substrate in thermal contact with a surface of a wavelength conversion layer, this permits better thermal management of any heat that is generated by the wavelength conversion layer.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

What is claimed is:

1. A wavelength conversion component for a light emitting device, comprising:
a wavelength conversion layer comprising a photo-luminescent material; and
a light transmissive thermally conductive substrate in thermal contact with a surface of the wavelength conversion layer.

2. The wavelength conversion component in claim 1, wherein the light transmissive thermally conductive substrate is composed of sapphire.

3. The wavelength conversion component in claim 1, wherein the light transmissive thermally conductive substrate utilizes phononic heat conduction.

4. The wavelength conversion component in claim 1, wherein a rate of heat transfer between the light transmissive thermally conductive substrate and the wavelength conversion layer is increased by increasing an area of an interface between the wavelength conversion layer and the light transmissive thermally conductive substrate.

5. The wavelength conversion component in claim 1, wherein a rate of heat transfer between the light transmissive thermally conductive substrate and the wavelength conversion layer is increased by decreasing a thickness of the light transmissive thermally conductive substrate.

6. The wavelength conversion component of claim 1, wherein the wavelength conversion layer comprises a mixture of a phosphor material and a light transmissive carrier material.

7. The wavelength conversion component in claim 1, wherein the light transmissive thermally conductive substrate is optically transparent to wavelengths in the range of 380 nm to 740 nm.

8. The wavelength conversion component of claim 7, wherein the light transmissive carrier material is optically transparent to wavelengths in the range of 380 nm to 740 nm.

9. The wavelength conversion component of claim 1, wherein the light transmissive carrier material comprises a curable liquid polymer selected from the group consisting of: a polymer resin, a monomer resin, an acrylic, an epoxy, a silicone, and a fluorinated polymer.

10. The wavelength conversion component of claim 1, wherein the wavelength conversion layer is deposited onto the light transmissive thermally conductive substrate using a method selected from the group consisting of: screen printing, slot die coating, roller coating, drawdown coating and doctor blading.

11. The wavelength conversion component of claim 1, wherein the wavelength conversion component has a three-dimensional configuration.

12. The wavelength conversion component of claim 1 embodied in a light emitting device that further comprises at least one solid-state light emitter operable to generate excitation light.

13. The wavelength conversion component of claim 12, wherein the light emitting device is selected from the group consisting of: downlights, light bulbs, linear lamps, lanterns, wall lamps, pendant lamps, chandeliers, recessed lights, track lights, accent lights, stage lighting, movie lighting, street lights, flood lights, beacon lights, security lights, traffic lights, headlamps, taillights, and signs.

14. A light emitting device comprising:
at least one solid-state light source operable to generate light; and
a wavelength conversion component located remotely to the at least one solid-state light source and operable to convert at least a portion of the light generated by the at least one solid-state light source to light of a different wavelength, wherein the emission product of the device comprises the combined light generated by the at least one source and the wavelength conversion component; and
wherein the wavelength conversion component comprises a wavelength conversion layer comprising photo-luminescent material and a light transmissive thermally conductive substrate in thermal contact with the wavelength conversion layer.

15. The device of claim 14, wherein the light transmissive thermally conductive substrate comprises a sapphire material.

16. The device of claim 14, wherein the light transmissive thermally conductive substrate is optically transparent to wavelengths in the range of 380 nm to 740 nm.

17. The device of claim 14, wherein the light transmissive thermally conductive substrate utilizes phononic heat conduction.

18. The device of claim 14, wherein a rate of heat transfer between the light transmissive thermally conductive substrate and the wavelength conversion layer is increased by increasing an area of an interface between the wavelength conversion layer and the light transmissive thermally conductive substrate.

19. The device of claim 14, wherein a rate of heat transfer between the light transmissive thermally conductive substrate and the wavelength conversion layer is increased by decreasing a thickness of the light transmissive thermally conductive substrate.

20. The device of claim 14, wherein the wavelength conversion layer comprises a mixture of a phosphor material and a light transmissive carrier material.

21. The device of claim 20, wherein the light transmissive carrier material is optically transparent to wavelengths in the range of 380 nm to 740 nm.

22. The device of claim 20, wherein the light transmissive carrier material comprises a curable liquid polymer selected from the group consisting of: a polymer resin, a monomer resin, an acrylic, an epoxy, a silicone, and a fluorinated polymer.

23. The device of claim 14, wherein the wavelength conversion layer is deposited onto the light transmissive thermally conductive substrate using a method selected from the group consisting of: screen printing, slot die coating, roller coating, drawdown coating and doctor blading.

24. The device of claim 14, wherein the solid-state light source is configured to generate blue light.

25. The device of claim 24, wherein the wavelength conversion component is operable to convert at least a portion of the blue light generated by the solid-state light source to white light.

26. The device of claim 14, wherein the light transmissive thermally conductive substrate is further connected to a heat sink configured to thermally conduct heat away from the light transmissive thermally conductive substrate.

27. The device of claim 26, wherein the heat sink is also configured thermally conduct heat away from the solid-state light source.

28. The device of claim 26, wherein the heat sink is composed of material selected from the group consisting of: a metal, an invar alloy, aluminum, copper, a thermally conductive polymer, and a thermally conductive ceramic.

29. The device of claim 14, wherein the wavelength conversion component has a three-dimensional configuration.

30. The light emitting device of claim 14, wherein the light emitting device is selected from the group consisting of: downlights, light bulbs, linear lamps, lanterns, wall lamps, pendant lamps, chandeliers, recessed lights, track lights, accent lights, stage lighting, movie lighting, street lights, flood lights, beacon lights, security lights, traffic lights, headlamps, taillights, and signs.

31. A linear lamp comprising:
an elongate housing;
a plurality of solid-state light emitters housed within the housing and configured along the length of the housing; and
an elongate wavelength conversion component remote to the plurality of solid-state light emitters and configured to in part at least define a light mixing chamber, wherein the elongate wavelength conversion component comprises:
an elongate wavelength conversion layer comprising a photo-luminescent material; and
an elongate light transmissive thermally conductive substrate in thermal contact with a surface of the wavelength conversion layer.

32. A downlight comprising:
a body comprising one or more solid-state light emitters, wherein the body is configured to be positioned within a downlighting fixture such that the downlight emits light in a downward direction; and
a wavelength conversion component remote to the one or more solid-state light emitters and configured to in part at least define a light mixing chamber, wherein the wavelength conversion component comprises
a wavelength conversion layer comprising a photo-luminescent material; and
a light transmissive thermally conductive substrate in thermal contact with a surface of the wavelength conversion layer.

33. A light bulb comprising:
a connector base configured to be inserted in a socket to form an electrical connection for the light bulb;
a body comprising one or more solid-state light emitters;
a wavelength conversion component having a three dimensional shape that is configured to enclose the one or more solid-state light emitters and to in part at least define a light mixing chamber, wherein the wavelength conversion component comprises:
a wavelength conversion layer comprising a photo-luminescent material; and
a light transmissive thermally conductive substrate in thermal contact with a surface of the wavelength conversion layer.
